(19) United States
(12) Patent Application Publication
(10) Pub. No.: US 2026/0187794 A1
(43) Pub. Date: Jul. 2, 2026

(54) MACHINE LEARNING ENABLED REGION-SPECIFIC LESION SEGMENTATION

(71) Applicant: Genentech, Inc., South San Francisco, CA (US)

(72) Inventors: Mahsa TORKAMAN, South San Francisco, CA (US); Richard Alan Duray CARANO, San Ramon, CA (US); Mohamed Skander JEMAA, San Francisco, CA (US)

(21) Appl. No.: 19/418,819

(22) Filed: Dec. 12, 2025

Related U.S. Application Data
(63) Continuation of application No. PCT/US2024/034990, filed on Jun. 21, 2024.
(60) Provisional application No. 63/509,981, filed on Jun. 23, 2023.

(51) Int. Cl. G06T 7/00; G06T 7/11

(52) U.S. Cl. CPC G06T 7/0012; G06T 7/11; G06T 2207/10081; G06T 2207/10104; G06T 2207/20081; G06T 2207/30096

(57) ABSTRACT

A method may include determining, within a first positron emission tomography and computed tomography (PET-CT) scan depicting a plurality of regions of a body, a first region including a lesion. A first portion of the first PET-CT scan depicting the first region but not a second region of the plurality of regions may be extracted to generate a second PET-CT scan having one or more initial dimensions. The one or more initial dimensions of the second PET-CT scan may be adjusted to one or more target dimensions by at least adding, to the second PET-CT scan, one or more voxels, and determining a value of each of the one or more voxels added to the second PET-CT scan. A segmentation model may be trained based on a training dataset that includes the second PET-CT scan adjusted to the one or more target dimensions.

### CROSS REFERENCE TO RELATED APPLICATION

This application is a bypass continuation of International Patent Application No. PCT/US2024/034990, filed Jun. 21, 2024, which claims the benefit of U.S. Provisional Application No. 63/509,981, filed Jun. 23, 2023, the disclosure of each of which is incorporated by reference herein in its entirety.

### TECHNICAL FIELD

The subject matter described herein relates generally to machine learning and more specifically to machine learning based lesion segmentation in positron emission tomography (PET) and computed tomography (CT) scans.

### INTRODUCTION

Medical imaging refers to techniques and processes for obtaining data characterizing a subject's internal anatomy and pathophysiology including, for example, images created by the detection of radiation either passing through the body (e.g., x-rays) or emitted by administered radiopharmaceuticals (e.g., gamma rays from intravenously administered radioactive tracers). By revealing internal anatomical structures obscured by other tissues such as skin, subcutaneous fat, and bones, medical imagining is integral to numerous medical diagnosis and/or treatments. Examples of medical imaging modalities include 2-dimensional imaging such as x-ray plain films, bone scintigraphy, and thermography. Examples of 3-dimensional imaging modalities include magnetic resonance imaging (MRI), computed tomography (CT), cardiac sestamibi scanning, and positron emission tomography (PET).

### SUMMARY

Systems, methods, and articles of manufacture, including computer program products, are provided for machine learning enabled lesion segmentation in positron emission tomography (PET) and computed tomography (CT) scans. In one aspect, there is provided a system for segmenting positron emission tomography (PET) and computed tomography (CT) scans. The at least one memory may include program code that provides operations when executed by the at least one processor. The operations may include: determining, within a first positron emission tomography and computed tomography (PET-CT) scan depicting a plurality of regions of a body, a first region including a first lesion; extracting, from the first PET-CT scan, a first portion of the first PET-CT scan depicting the first region but not a second region of the plurality of regions to generate a second PET-CT scan having one or more initial dimensions; adjusting, to one or more target dimensions, the one or more initial dimensions of the second PET-CT scan, the adjusting includes adding, to the second PET-CT scan, one or more voxels, and determining a value of each of the one or more voxels added to the second PET-CT scan; training, based at least on a training dataset that includes the second PET-CT scan adjusted to the one or more target dimensions, a segmentation model; and applying the trained segmentation model to identify one or more lesions present in a region-specific PET-CT scan depicting the first region but not the second region of the plurality of regions of the body.

In another aspect, there is provided a method for segmenting positron emission tomography (PET) and computed tomography (CT) scans. The method may include: determining, within a first positron emission tomography and computed tomography (PET-CT) scan depicting a plurality of regions of a body, a first region including a first lesion; extracting, from the first PET-CT scan, a first portion of the first PET-CT scan depicting the first region but not a second region of the plurality of regions to generate a second PET-CT scan having one or more initial dimensions; adjusting, to one or more target dimensions, the one or more initial dimensions of the second PET-CT scan, the adjusting includes adding, to the second PET-CT scan, one or more voxels, and determining a value of each of the one or more voxels added to the second PET-CT scan; training, based at least on a training dataset that includes the second PET-CT scan adjusted to the one or more target dimensions, a segmentation model; and applying the trained segmentation model to identify one or more lesions present in a region-specific PET-CT scan depicting the first region but not the second region of the plurality of regions of the body.

In another aspect, there is provided a computer program product including a non-transitory computer readable medium storing instructions. The instructions may cause operations may executed by at least one data processor. The operations may include: determining, within a first positron emission tomography and computed tomography (PET-CT) scan depicting a plurality of regions of a body, a first region including a first lesion; extracting, from the first PET-CT scan, a first portion of the first PET-CT scan depicting the first region but not a second region of the plurality of regions to generate a second PET-CT scan having one or more initial dimensions; adjusting, to one or more target dimensions, the one or more initial dimensions of the second PET-CT scan, the adjusting includes adding, to the second PET-CT scan, one or more voxels, and determining a value of each of the one or more voxels added to the second PET-CT scan; training, based at least on a training dataset that includes the second PET-CT scan adjusted to the one or more target dimensions, a segmentation model; and applying the trained segmentation model to identify one or more lesions present in a region-specific PET-CT scan depicting the first region but not the second region of the plurality of regions of the body.

In some variations, one or more features disclosed herein including the following features can optionally be included in any feasible combination.

In some variations, a first tumor mask identifying a first plurality of voxels depicting one or more lesions present in the first PET-CT scan may be determined. In response to determining that an overlap between the first tumor mask and the first region of the body satisfies a first threshold, the second PET-CT scan may be generated based at least on the first PET-CT scan by at least extracting the first portion of the first PET-CT scan.

In some variations, the second PET-CT scan may be generated based at least on the first PET-CT scan in response to determining that the first tumor mask satisfies a second threshold.

In some variations, the second threshold may include at least one of a tumor volume and a distance to another lesion.

In some variations, an organ mask identifying a second plurality of voxels depicting an organ of interest present in the first region of the body may be determined. In response to determining that an overlap between the first tumor mask and the organ mask satisfies the first threshold, the second PET-CT scan may be generated based at least on the first PET-CT scan.

In some variations, a second tumor mask identifying a second plurality of voxels depicting one or more lesions present in a multi-region PET-CT scan may be determined. In response to determining that (i) an overlap between the second tumor mask and the first region of the body fails to satisfy the first threshold or (ii) the second tumor mask fails to satisfy a second threshold including at least one of a tumor volume and a distance to another lesion, the second PET-CT scan may be generated based on the first PET-CT scan but not the multi-region PET-CT scan.

In some variations, the training dataset may be generated to include a first ground truth annotation identifying a first plurality of voxels depicting the first lesion in the second PET-CT scan.

In some variations, a second lesion present in the second PET-CT scan may be determined as failing to satisfy one or more thresholds including at least one of a tumor volume and a distance to another lesion. In response to determining that the second lesion fails to satisfy the one or more thresholds, the training dataset may be generated to exclude a second ground truth annotation identifying a second plurality of voxels depicting the second lesion in the second PET-CT scan.

In some variations, the adjusting of the one or more initial dimensions of the second PET-CT scan may include performing a first adjustment to a first dimension of the second PET-CT scan, and performing, based at least on the first adjustment, a second adjustment to a second dimension of the second PET-CT scan and a third adjustment to a third dimension of the second PET-CT scan.

In some variations, the first adjustment to the first dimension of the second PET-CT scan may include adding, to a first quantity of voxels along the first dimension of the second PET-CT scan, at least a first voxel to increase the first quantity of voxels to a maximum quantity of voxels, and determining a first value of the first voxel.

In some variations, the first value of the first voxel may be determined based at least on a second value of a second voxel within a threshold distance of the first voxel.

In some variations, the first value of the first voxel may correspond to a first level of metabolic activity and a first tissue density at a first location of the first voxel. The second value of the second voxel may correspond to a second level of metabolic activity and a second tissue density at a second location of the second voxel.

In some variations, the second adjustment to the second dimension of the second PET-CT scan may include adding, to a second quantity of voxels along the second dimension of the second PET-CT scan, at least a second voxel to increase the second quantity of voxels to the maximum quantity of voxels. The third adjustment to the third dimension of the second PET-CT scan may include adding, to a third quantity of voxels along the third dimension of the second PET-CT scan, at least a third voxel to increase the third quantity of voxels to the maximum quantity of voxels.

In some variations, each of the second voxel and the third voxel may be assigned a first value for a level of metabolic activity and a second value for tissue density or x-ray attenuation.

In some variations, the first value may be 0 and the second value may be −1024.

In some variations, the maximum quantity of voxels may be 64, 128, 256, or 512.

In some variations, the first PET-CT scan may be a full-body scan of the body. The second PET-CT scan may be generated to depict some but not all of the plurality of regions depicted in the full-body scan of the body.

In some variations, the plurality of regions of the body depicted in the first PET-CT scan may include a plurality of organs in the body. The second PET-CT scan may be generated to depict some but not all of the plurality of organs in the body.

In some variations, the first region of the plurality of regions in the second PET-CT scan may depict at least a first organ and the second region of the plurality of regions removed from the first PET-CT scan may depict at least a second organ.

In some variations, the extracting of the first portion of the first PET-CT scan depicting the first region of the body may include identifying a plurality of voxels comprising the first portion of the first PET-CT scan based at least on a range of intensity values exhibited by the plurality of voxels.

In some variations, the extracting of the first portion of the first PET-CT scan depicting the first region of the body may include identifying a plurality of voxels comprising the first portion of the first PET-CT scan based at least on a difference between a maximum intensity value and a minimum intensity value exhibited by the plurality of voxels.

In some variations, the extracting of the first portion of the first PET-CT scan depicting the first region of the body may include determining a first range of intensity values exhibited by the first portion of the first PET-CT scan excluding the voxel; determining a second range of intensity values exhibited by the first portion of the first PET-CT scan including the voxel; identifying, based at least on a difference between the first range of intensity values and the second range of intensity values satisfying one or more thresholds, the voxel for inclusion in the first portion of the first PET-CT scan; and determining, based at least on the difference between the first range of values and the second range of values failing to satisfy the one or more thresholds, excluding the voxel from the first portion of the first PET-CT scan.

In some variations, the first region of the plurality of regions may include one of small intestines, large intestines, lungs, thyroid, prostate, pancreas, and cervix.

In some variations, the segmentation model may include an encoder and a decoder.

In some variations, the segmentation model may further include one or more transformation blocks coupling an output of the encoder to an input of the decoder.

In some variations, the trained segmentation model may identify, within the region-specific PET-CT scan, a plurality of voxels depicting the one or more lesions present in the first region of the body.

In some variations, a metabolic tumor volume of the one or more lesions present in the first region of the body may be determined based at least on the plurality of voxels.

In some variations, at least one of a response to a stage of a disease, a grade of the disease, a treatment for the disease, a progression of the disease, and a disease burden may be determined based at least on the metabolic tumor volume.

In some variations, the first PET-CT scan and the second PET-CT scan may be three-dimensional volumes.

In some variations, the first PET-CT scan and the second PET-CT scan may be a series of two-dimensional slices.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to fluorodeoxyglucose avid (FDG-avid) cancers such as some types small bowel tumors, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a machine learning based medical imaging analysis system, in accordance with some example embodiments;

FIG. 2A depicts a schematic diagram illustrating an example of a process for machine learning enabled lesion segmentation in positron emission tomography and computed tomography (PET-CT) scans, in accordance with some example embodiments;

FIG. 2B depicts a schematic diagram illustrating another example of a process for machine learning enabled lesion segmentation in positron emission tomography and computed tomography (PET-CT) scans, in accordance with some example embodiments;

FIG. 2C depicts a schematic diagram illustrating an example of a workflow for machine learning enabled lesion segmentation in positron emission tomography and computed tomography (PET-CT) scans, in accordance with some example embodiments;

FIG. 3 depicts a flowchart illustrating an example of a process for machine learning enabled lesion segmentation in positron emission tomography and computed tomography (PET-CT) scans, in accordance with some example embodiments;

FIG. 4 depicts a flowchart illustrating an example of a process for preprocessing a positron emission tomography and computed tomography (PET-CT) scan, in accordance with some example embodiments;

FIG. 5 depicts a flowchart illustrating an example of a process for identifying one or more positron emission tomography and computed tomography (PET-CT) scans for inclusion in a training dataset, in accordance with some example embodiments;

FIG. 6 depicts a schematic diagram illustrating an example architecture for implementing a segmentation model, in accordance with some example embodiments;

FIG. 7A depicts graphs illustrating a comparison of the error bars and 95% confidence intervals for Dice in the Goya test set for a region-specific (e.g., organ-focused) segmentation approach and a multi-region (e.g., whole-body) segmentation approach, in accordance with some example embodiments;

FIG. 7B depicts graphs illustrating a comparison of the error bars and 95% confidence intervals for Dice in the Gallium test set for a region-specific (e.g., organ-focused) segmentation approach and a multi-region (e.g., whole-body) segmentation approach, in accordance with some example embodiments;

FIG. 8A depicts graphs illustrating a comparison of the automated total metabolic tumor volume (TMTV) with ground truth values in diffuse large B-cell lymphoma (DLBCL) test patients, in accordance with some example embodiments;

FIG. 8B depicts graphs illustrating a comparison of the automated total metabolic tumor volume (TMTV) with ground truth values in follicular lymphoma (FL) test patients, in accordance with some example embodiments;

FIG. 9 depicts a comparison of a first performance of a segmentation model trained to perform lesion segmentation on organ-focused positron emission tomography and computed tomography (PET-CT) scans and a second performance of a segmentation model trained to perform lesion segmentation on whole-body positron emission tomography and computed tomography (PET-CT) scans, in accordance with some example embodiments; and

FIG. 10 depicts a block diagram illustrating an example of a computing system, in accordance with some example embodiments.

When practical, similar reference numbers denote similar structures, features, or elements.

### DETAILED DESCRIPTION

Various modalities of medical imaging may be applied to obtain data characterizing a subject's internal anatomy as well as pathophysiology. Computed tomography (CT) is an example of a three-dimensional imaging modality in which a series of X-rays are captured to create cross-sectional images (e.g., patches, slices, and/or the like) of the bones, blood vessels, and soft tissues inside the body. A computed tomography scan may be a three-dimensional volume formed by a series of two-dimensional images (or slices) in which each pixel is associated with an intensity value indicative of a tissue density or x-ray attenuation at the corresponding location in the subject's body. Another example of a three-dimensional imaging modality is positron emission tomography (PET), which captures radioactivity signals indicative of cellular metabolic activities inside the subject's body. A positron emission tomography scan may be a three-dimensional volume formed by a series of two-dimension images (or slices) in which each pixel is associated with an intensity value indicative of the level of cellular metabolic activity (e.g., glucose uptake) at the corresponding location in the subject's body. In some cases, a single gantry incorporating a positron emission tomography (PET) scanner and a computed tomography (CT) scanner may be capable of acquiring positron emission tomography (PET) scans and computed tomography (CT) scans during a same session. The resulting positron emission tomography (PET) scan and computed tomography (CT) scan may be combined into a single superposed (e.g., co-registered) image (e.g., a PET-CT scan) in which the spatial distribution of metabolic activities depicted in the positron emission tomography (PET) scan is aligned with the anatomical structures depicted in the computed tomography (CT) scan.

In some example embodiments, an analysis controller may perform lesion segmentation by at least applying a segmentation model to identify, within a positron emission tomography and computed tomography (PET-CT) scan, one or more voxels depicting a lesion. For example, in some cases, the PET-CT scan may be a three-dimensional volume formed by a series of two-dimensional images (or slices). A single two-dimensional image (or slice) in the PET-CT scan may include a plurality of pixels forming, for example, a two-dimensional plane. Meanwhile, in some cases, the PET-CT scan may include a plurality of voxels, with each voxel in the three-dimensional volume of the PET-CT scan corresponding to a single pixel in one of the two-dimensional images (or slices) forming the PET-CT scan. A single voxel in the positron emission tomography (PET) scan forming the PET-CT scan may be associated with an intensity value indicative of a level of metabolic activity (e.g., standard update value (SUV)) at a corresponding location in a patient's body and while the corresponding voxel in the co-registered computed tomography (CT) scan may be associated with an intensity value indicative of a tissue density or x-ray attenuation at the same location. In some cases, the aforementioned segmentation model may determine whether a voxel in the PET-CT scan is a part of a lesion based at least on the intensity value of the voxel and that of one or more neighboring voxels. That is, the segmentation model may determine whether the voxel is a part of a lesion based at least on the level of metabolic activity and the tissue density (or x-ray attenuation) present at the corresponding location in the patient's body. In doing so, the segmentation model may generate a tumor mask in which the voxel is assigned a first value (e.g., “1”) to indicate that the voxel is a part of a lesion or a second value (e.g., “0”) to indicate that the voxel is not a part of a lesion.

The segmentation model may perform poorly when trained to operate on PET-CT scans that depict large, monolithic areas of the body (e.g., whole body scans and/or the like). The voxels across a large area of the body, such as those in a whole-body scan and/or the like, may exhibit a wider range of intensity values than the intensity values of the voxels depicting a lesion. Thus, in some cases, the poor performance of a segmentation model trained on PET-CT scans encompassing large areas of the body (e.g., whole body scans and/or the like) may be attributable at least in part to the low signal-to-noise ratio (SNR) of these scans. That is, in a PET-CT scan depicting a large area of the body (e.g., a whole-body scan and/or the like), the signal associated with the voxels depicting a lesion tends to be obscured by the high noise level imposed by the background voxels (or the voxels not depicting a lesion).

Anatomical differences across the body may also engender significant variations in the range of intensity values of voxels across different regions of the body. However, the voxels within a single region of the body may be more homogenous at least because the voxels within the same region of the body tend to exhibit more uniform intensity values (or intensity values from a more confined range of intensity values). For example, in some cases, a first background voxel (or a voxel not depicting a lesion) from a first region of the body may be exhibit a first intensity value that is more similar to the second intensity value of a second background voxel from the first region of the body than the third intensity value of a third background voxel from a second region of the body. Accordingly, in some example embodiments, the analysis controller may improve the performance of a segmentation model by at least training the segmentation model to perform lesion segmentation based on PET-CT scans that have been resampled to exclude at least one region of the body. For instance, in some cases, the analysis controller may train the segmentation model to perform lesion segmentation based on region-specific PET-CT scans, which are PET-CT scans that have been resampled to depict a first region but not a second region of the body. As described in more detail below, the performance of the segmentation model may be improved at least because the signal-to-noise ratio (SNR) and background homogeneity of region-specific PET-CT scans may be increased by excluding at least one region of the body therefrom.

In some example embodiments, the analysis controller may resample a first PET-CT scan depicting multiple regions of the body by at least determining, within the first PET-CT scan, a first region including a first lesion. The analysis controller may extract a first portion of the first PET-CT scan depicting the first region but not a second region of the body to generate a second PET-CT scan. In some cases, the resampling may further include the analysis controller adjusting, to one or more target dimensions, one or more initial dimensions of the second PET-CT scan. For example, in some cases, the second PET-CT scan may be adjusted to the one or more target dimensions by at least adding, to the first portion of the first PET-CT scan, one or more voxels, and determining a value of each of the one or more voxels added to the second PET-CT scan. Furthermore, the analysis controller may generate a training dataset to include the second PET-CT scan adjusted to the one or more target dimensions as well as a ground-truth annotation identifying one or more voxels depicting the first lesion in the second PET-CT scan. In some cases, the analysis controller may train, based at least on a training dataset that includes the second PET-CT scan adjusted to the one or more target dimensions, the segmentation model. The trained segmentation model may be applied to identify one or more lesions present, for example, in a region-specific PET-CT scan depicting the first region of the body.

In some example embodiments, the analysis controller may generate the training dataset based on one or more multi-region PET-CT scans in which the lesions present in the first region of the body satisfies one or more thresholds. For example, in some cases, the analysis controller may determine a first tumor mask identifying a first plurality of voxels depicting one or more lesions present in a multi-region PET-CT scan, such as the first PET-CT scan. Where the overlap between the first tumor mask and the first region of the body satisfies a first threshold (e.g., 20% and/or the like), the analysis controller may generate a region-specific scan, such as the second PET-CT scan, based at least on the first PET-CT scan, for example, by at least extracting the first portion of the first PET-CT. In cases where the first region includes or is limited to one or more specific organs-of-interest in the body (e.g., small intestines, large intestines, lungs, thyroid, prostate, pancreas, cervix, and/or the like), the analysis controller may generate the second PET-CT scan based on the first PET-CT scan if the overlap between the first tumor mask and an organ mask including the one or more organs satisfies the first threshold (e.g., 20% and/or the like). Contrastingly, where the overlap between the first region of the body and a second tumor mask identifying one or more lesions present in a multi-region PET-CT scan fails to satisfy the first threshold (e.g., 20% and/or the like), the analysis controller may omit that multi-region PET-CT when generating the training dataset for the segmentation model. In doing so, the analysis controller may ensure that the training dataset for training the segmentation includes resampled PET-CT scans in which at least one lesion is present in the first region of the body.

In some example embodiments, in addition to having a sufficient overlap with the first region of the body, the analysis controller may exclude, from the resampled PET-CT scans in the training dataset for the segmentation model, one or more PET-CT scans that depict lesions that are more likely to be artifacts. For example, in some cases, the analysis controller may determine whether the first tumor mask identifying the one or more lesions present in the first region of the body satisfies a second threshold. In some cases, the second threshold may include at least one of a tumor volume and a distance to another lesion. Accordingly, the second PET-CT scan may be determined based at least on the first PET-CT scan, for example, by at least extracting the first portion but not the second portion of the first PET-CT scan, if the one or more lesions identified by the first tumor mask exceed a threshold volume (e.g., 0.8 milliliters and/or the like) and/or are located within a threshold distance away from another lesion (e.g., 10 voxels and/or the like). Contrastingly, where the one or more lesions identified by the first tumor mask are smaller than the threshold volume (e.g., 0.8 milliliters and/or the like) and are located more than the threshold distance away from another lesion (e.g., 10 voxels and/or the like), the analysis controller may omit the first PET-CT scan when generating the training dataset for the segmentation model.

In some example embodiments, upon extracting the first portion of the first PET-CT scan, the analysis controller may adjust the one or more initial dimensions of the resulting second PET-CT scan by at least performing a first adjustment to a first dimension of the second PET-CT scan. Furthermore, the analysis controller may perform, based at least on the first adjustment, a second adjustment to a second dimension of the second PET-CT scan and a third adjustment to a third dimension of the second PET-CT scan. In some cases, the first adjustment to the first dimension of the first PET-CT scan may include adding, to a first quantity of voxels along the first dimension of the second PET-CT scan, at least a first voxel to increase the first quantity of voxels to a maximum quantity of voxels (e.g., 64, 128, 256, 512, and/or the like). The first value of the first voxel in this case may be determined based at least on a second value of a second voxel within a threshold distance of the first voxel. In some cases, the second adjustment to the second dimension of the second PET-CT scan may include adding, to a second quantity of voxels along the second dimension of the second PET-CT scan, at least a second voxel to increase the second quantity of voxels to the maximum quantity of voxels while the third adjustment to the third dimension of the second PET-CT scan may include adding, to a third quantity of voxels along the third dimension of the second PET-CT scan, at least a third voxel to increase the third quantity of voxels to the maximum quantity of voxels. The second voxel and the third voxel may each be assigned a first value (e.g., “0”) for a level of metabolic activity and a second value (e.g., “−1024”) for tissue density or x-ray attenuation.

In some example embodiments, the analysis controller may extract the first portion of the first PET-CT scan depicting the first region of the body to maximize the homogeneity of the background voxels (or voxels not depicting a lesion) included in the first portion of the first PET-CT scan. For example, in some cases, the analysis controller may extract the first portion of the first PET-CT scan by at least identifying a plurality of voxels forming the first portion of the first PET-CT scan. In some cases, the plurality of voxels forming the first portion of the first PET-CT scan may be identified based at least on the range of intensity values exhibited by the voxels including, for example, the difference between the maximum intensity value and the minimum intensity value of the voxels selected for inclusion in the first portion of the first PET-CT scan. For instance, in some cases, a voxel may be identified for inclusion in the plurality of voxels forming the first portion of the first PET-CT if the intensity value of the pixel satisfies one or more criteria. In some cases, the intensity value of the voxel may be determined to satisfy the one or more criteria if the intensity value of the voxel is within a certain range of intensity values. Alternatively, the intensity value of the voxel may be determined to satisfy the one or more criteria if the inclusion of the voxel in the first portion of the first PET-CT scan does not engender an above-threshold increase in the range of intensity values present in the first portion of the first PET-CT scan. By excluding voxels that skew the range of intensity values present in the first portion of the first PET-CT scan, the analysis controller may increase the signal-to-noise ratio (SNR) and background homogeneity of the second PET-CT scan generated therefrom. Training the segmentation model to operate on region-specific PET-CT scans with higher signal-to-noise ratio (SNR) and background homogeneity, such as PET-CT scans that have been resampled to depict specific regions of the body while excluding others, may maximize the performance of the segmentation model when applied to region-specific PEC-CT scans.

In some example embodiments, when applied to the region-specific PET-CT scan depicting the first region but not the second region of the body, the trained segmentation model may identify the one or more lesions present therein by at least identifying a plurality of voxels depicting the one or more lesions. In some cases, the analysis controller may determine, based at least on the plurality of voxels depicting the one or more lesions in the region-specific PET-CT scan, a metabolic tumor volume (or total metabolic tumor volume (TMTV)) of the one or more lesions. Furthermore, in some cases, the analysis controller may determine, based at least on the metabolic tumor volume (or total metabolic tumor volume (TMTV)), at least one of a response to a stage of a disease, a grade of the disease, a treatment for the disease, a progression of the disease, and a disease burden. For example, in some cases, the analysis controller may determine, based at least on the metabolic tumor volume (or total metabolic tumor volume (TMTV)), a response to a treatment for a disease such as complete metabolic response (CMR), objective response (OR), four-category assessment, and/or the like. Alternatively, and/or additionally, the analysis controller may determine, based at least on the metabolic tumor volume (or total metabolic tumor volume (TMTV)) from two or more different timepoints, a progression of the disease.

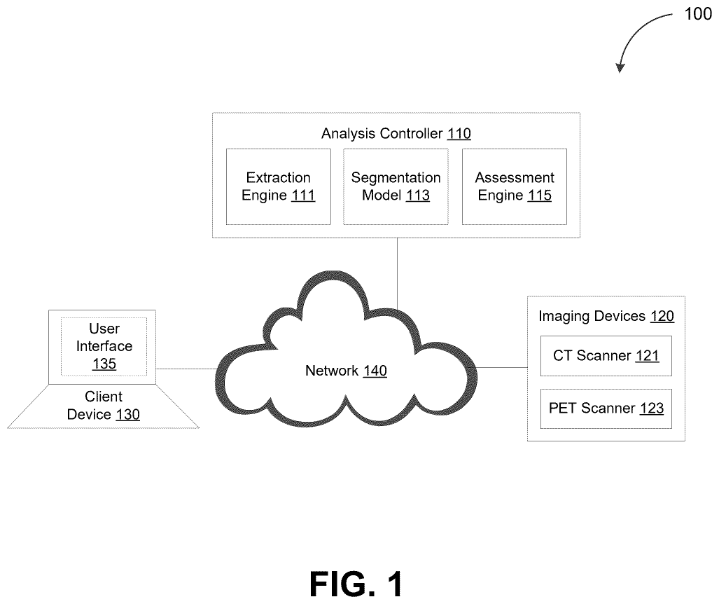

FIG. 1 depicts a system diagram illustrating an example of a machine learning based medical imaging analysis system 100, in accordance with some example embodiments. Referring to FIG. 1, the machine learning based medical imaging analysis system 100 may include an analysis controller 110, one or more imaging devices 120, and a client device 130. As shown in FIG. 1, the analysis controller 110, the one or more imaging devices 120, and the client device 130 may be communicatively coupled via a network 140. The one or more imaging devices 120 may include, for example, a computed tomography (CT) scanner 121 and a positron emission tomography (PET) scanner 123. The client device 130 may be a processor-based device including, for example, a smartphone, a tablet computer, a wearable apparatus, a virtual assistant, an Internet-of-Things (IoT) appliance, and/or the like. The network 140 may be a wired network and/or a wireless network including, for example, a wide area network (WAN), a local area network (LAN), a virtual local area network (VLAN), a public land mobile network (PLMN), the Internet, and/or the like.

In some example embodiments, the analysis controller 110 may perform segmentation by at least training a segmentation model 113 to operate on a region-specific positron emission tomography and computed tomography (PET-CT) scan extracted from a PET-CT scan depicting multiple regions of the body. For example, in some cases, the analysis controller 110 may receive a first PET-CT scan generated by the one or more imaging devices 120 (e.g., the computed tomography scanner 121, the positron emission tomography scanner (PET) scanner 123, and/or the like). The first PET-CT scan may be a three-dimensional volume in which a three-dimensional computed tomography (CT) scan captured by the CT scanner 121 is co-registered with a three-dimensional positron emission tomography (PET) scan captured by the PET scanner 123. Furthermore, in some cases, the first PET-CT scan received from the one or more imaging devices 120 may depict multiple regions of the body (e.g., a whole-body scan and/or the like). As described in more detail below, the analysis controller 110 may resample the first PET-CT scan depicting multiple regions of the body in order to generate a second PET-CT scan that includes a first region of the body depicted in the first PET-CT scan but not a second region of the body. In doing so, the second PET-CT scan, which depicts one or more specific regions of the body, may exhibit a higher signal-to-noise ratio (SNR) and background homogeneity than the first PET-CT scan. Training the segmentation model 113 to operate on the second PET-CT scan instead of the first PET-CT scan may improve the performance of the segmentation model 113 (e.g., precision, recall, F1 score, and/or the like).

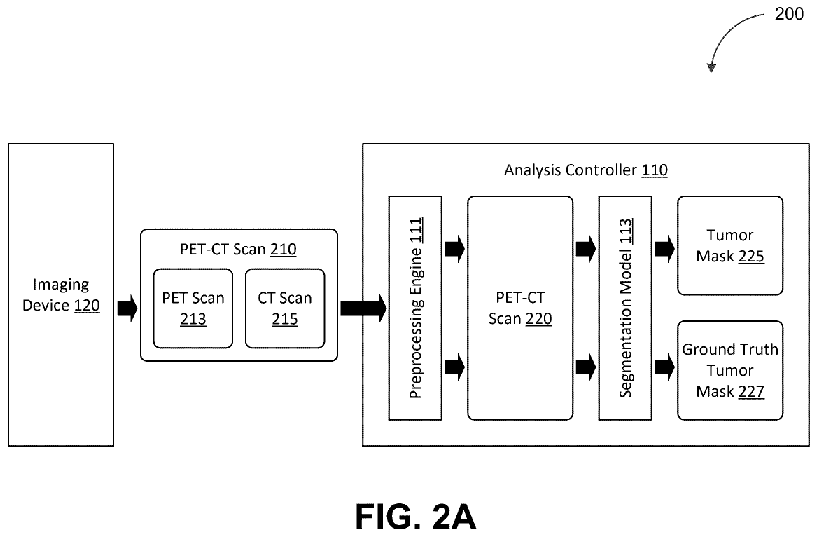

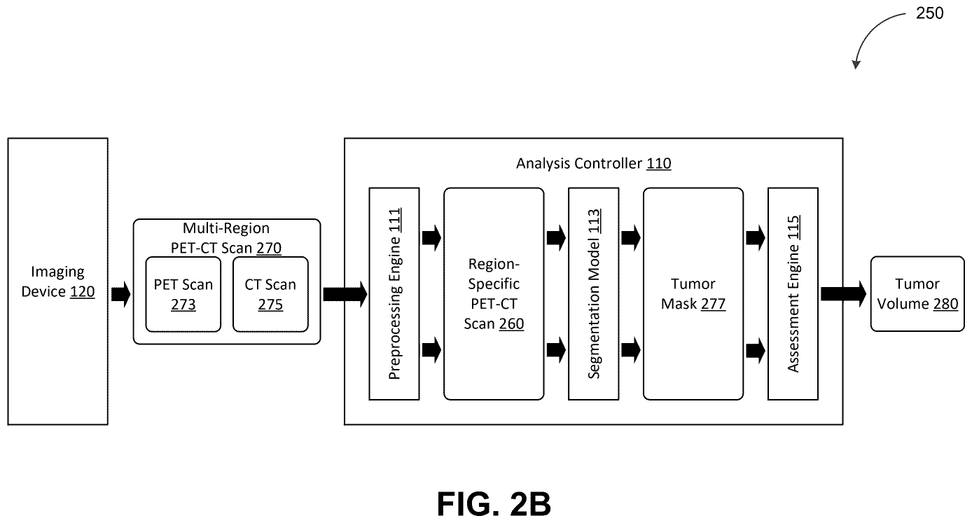

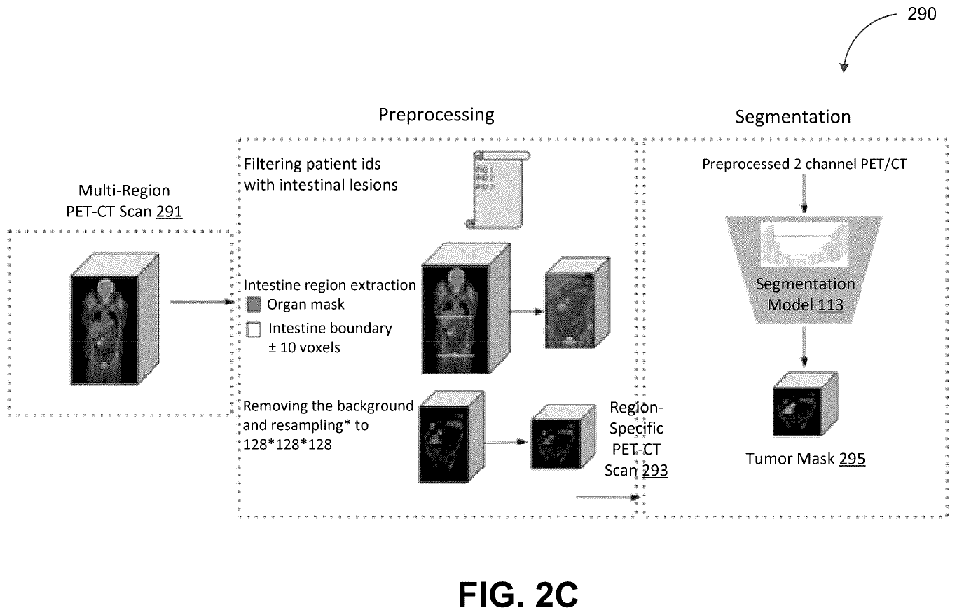

FIG. 2A depicts a schematic diagram illustrating an example of a process 200 for training the segmentation model 113 to perform lesion segmentation in positron emission tomography (PET) and computed tomography (CT) scans, in accordance with some example embodiments. As shown in FIG. 2A, the analysis controller 110 may receive, from the one or more imaging devices 120, a first PET-CT scan 210. In some cases, the first PET-CT scan 210 may include a positron emission tomography (PET) scan 213 that is co-registered with a computed tomography (CT) scan 215. Moreover, in some cases, the positron emission tomography (PET) scan 213 and the computed tomography (CT) scan 215 may each be a three-dimensional volume formed by a series of two-dimensional images (or slices). Accordingly, the first PET-CT scan 210 may be a three-dimensional volume including a plurality of voxels, with each voxel corresponding to a pixel in one of the two-dimensional images (or slices) forming the first PET-CT scan 210.

In some cases, each of the two-dimensional images (or slices) forming the first PET-CT scan 210 may be a two-dimensional plane formed from a plurality of pixels, for example, along the x-axis and γ-axis. The three-dimensional volume of the first PET-CT scan 210 may be formed by stacking the two-dimensional images (or slices) along, for example, the z-axis. A single voxel in the three-dimensional volume of the first PET-CT scan 210 may correspond to a pixel in one of the constituent two-dimensional images (or slices) of the first PET-CT scan 210. For example, a first voxel having the first three-dimensional coordinates (x₁, y₁, z₁) in the first PET-CT scan 210 may correspond to a first pixel having the two-dimensional coordinates (x₁, y₁) in a first two-dimensional image (or slice) at z₁ and a second voxel having the second three-dimensional coordinates (x₂, y₂, z₂) may correspond to a second pixel having the two-dimensional coordinates (x₂, y₂) in a second two-dimensional image (or slice) at z₂. Moreover, each voxel in the first PET-CT scan 210 may have a first intensity value indicative of a level of metabolic activity (e.g., standard update value (SUV)) at a corresponding location in a patient's body and a second intensity value indicative of a tissue density or x-ray attenuation at the same location.

In some example embodiments, the analysis controller 110 may generate, based at least on the first PET-CT scan 210, a second PET-CT scan 220 that is then used as a training sample for training the segmentation model 113. In the example shown in FIG. 2A, the analysis controller 110 may include a preprocessing engine 111 that generates the second PET-CT scan 220 by at least resampling the first PET-CT scan 210 received from the one or more imaging devices 120. For example, in some cases, the first PET-CT scan 210 may depict multiple regions of the body. Accordingly, the preprocessing engine 111 may extract, from the first PET-CT scan 210 depicting multiple regions of the body, a first portion of the first PET-CT scan 210 depicting a first region of the body but not a second region of the body. That is, the preprocessing engine 111 may generate the second PET-CT scan 220 to exclude at least one of the regions depicted in the first PET-CT scan 210. The first PET-CT scan 210 may a low signal-to-noise ratio (SNR) and background homogeneity due at least in part to the wide discrepancy in voxel intensity values across multiple different regions of the body. As such, by eliminating one or more of the regions present in the first PET-CT scan 210, such as regions that do not contain an organ-of-interest, the resulting second PET-CT scan 220 may exhibit a higher signal-to-noise ratio (SNR) and background homogeneity than the first PET-CT scan 210.

In some example embodiments, the preprocessing engine 111 may further generate the second PET-CT scan 220 by at least resampling the first portion of the first PET-CT scan 210 extracted from the first PET-CT scan 210. For example, in some cases, extracting the first portion of the first PET-CT scan 210 depicting the first region but not the second region of the body may generate the second PET-CT scan 220 having one or more initial dimensions. As described in more detail below, the resampling of the first portion of the first PET-CT scan 210 may include adjusting, to one or more target dimensions, the one or more initial dimensions of the second PET-CT scan 220. For instance, in some cases, the one or more initial dimensions of the second PET-CT scan 220 may be adjusted by adding, to the second PET-CT scan 220, one or more voxels to achieve the one or more target dimensions. Furthermore, in some cases, the one or more initial dimensions of the second PET-CT scan 220 may be adjusted by at least determining a value (e.g., an intensity value and/or the like) of the one or more voxels added to the second PET-CT scan 220.

In some example embodiments, the analysis controller 110 may train, based at least on a training dataset that includes the second PET-CT scan 220 adjusted to the one or more target dimensions, the segmentation model 113. As noted, training the segmentation model 113 to operate on the second PET-CT scan 220, which depicts one or more specific regions of the body, may improve the performance of the segmentation model 113. For example, as shown in FIG. 2A, the analysis controller 110 may train the segmentation model 113 by at least applying the segmentation model 113 to generate a tumor mask 225 identifying a first plurality of voxels depicting one or more lesions present in the second PET-CT scan 220. The training of the segmentation model 113 may further include adjusting the segmentation model 113 (e.g., one or more weights applied by the segmentation model 113) to minimize a difference (e.g., Dice coefficient and/or the like) between the tumor mask 225 and a ground truth tumor mask 227 identifying a second plurality of voxels depicting one or more actual lesions present in the second PET-CT scan 220.

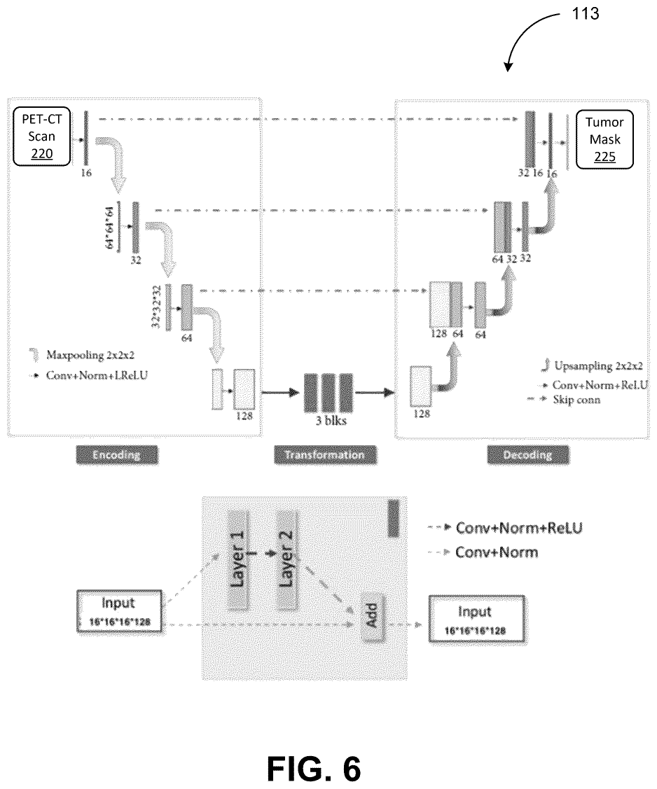

To further illustrate, FIG. 6 depicts a schematic diagram illustrating an example architecture for implementing the segmentation model 113, in accordance with some example embodiments. In the example shown in FIG. 6, the segmentation model 113 may include cascaded two-dimensional and three-dimensional artificial neural networks, such as convolutional neural networks. For example, as shown in FIG. 6, the segmentation model 113 may include an encoder trained to generate an encoding, for example, of the second PET-CT scan 220. Furthermore, the segmentation model 113 may also include a decoder trained to decode the encoding of the second PET-CT scan 220. In some cases, the output of the decoder decoding the encoding of the second PET-CT scan 220 may be the tumor mask 225. Moreover, in the example shown in FIG. 6, the segmentation model 113 may include one or more transformation blocks that couples an output of the encoder to the input of the decoder. Accordingly, in the example shown in FIG. 6, the encoding of the second PET-CT scan 220 output by the encoder may undergo one or more transformations before being ingested by the decoder and decoded into the tumor mask 225.

In some cases, the example of the segmentation model 113 shown in FIG. 6 may implement a two-step approach involving two-dimensional and three-dimensional segmentation. For example, in some cases, individual slices of the PET-CT scan 220 may undergo two-dimensional segmentation using an adapted UNet before a refined 3D VNet architecture is employed to enhance the two-dimensional segmentation. The tumor mask 225 may be derived by averaging the tumor masks resulting from the two-dimensional segmentation performed by the UNet and the subsequent three-dimensional segmentation performed by the VNet.

FIG. 2B depicts a schematic diagram illustrating an example of a process 250 for machine learning enabled lesion segmentation in positron emission tomography (PET) and computed tomography (CT) scans, in accordance with some example embodiments. Referring to FIGS. 1 and 2A-B, once trained, the segmentation model 113 may be applied to identify one or more lesions present, for example, in a region-specific PET-CT scan 260. In some cases, the region-specific PET-CT scan 260 may also be preprocessed, for example, by the preprocessing engine 111, to depict the first region but not the second region of the body. For example, as shown in FIG. 2B, the analysis controller 110 may receive, from the one or more imaging devices 120, a multi-region PET-CT scan 270 (e.g., including a PET scan 273 co-registered with a CT scan 275) that depicts multiple regions of the body. The preprocessing engine 111 may generate the region-specific PET-CT scan 260 by at least extracting, from the multi-region PET-CT scan 270, a portion of the multi-region PET-CT scan 270 that depicts the first region of the body but not the second region of the body. Furthermore, the preprocessing engine 111 may generate the region-specific PET-CT scan 260 by at least adjusting, to one or more target dimensions, the region-specific PET-CT scan 260.

Referring again to FIG. 2B, the analysis controller 110 may apply the trained segmentation model 113 to identify one or more lesions present in the region-specific PET-CT scan 260 adjusted to the one or more target dimensions. For instance, in the example shown in FIG. 2B, the segmentation model 113 may generate a tumor mask 277 identifying a plurality of voxels in the region-specific PET-CT scan 260 that depicts a lesion. As shown in FIG. 2B, in some cases, the analysis controller 110 may include an assessment engine 115 that determines, based at least on the tumor mask 277, a tumor volume 280 (e.g., a metabolic tumor volume, a total metabolic tumor volume (TMTV), and/or the like). In some cases, the assessment engine 115 may further determine, based at least on the tumor volume 280, at least one of a stage of a disease, a grade of the disease, a response to a treatment for the disease, a progression of the disease, and a disease burden.

FIG. 2C depicts a schematic diagram illustrating an example of a workflow 290 for machine learning enabled lesion segmentation in positron emission tomography and computed tomography (PET-CT) scans, in accordance with some example embodiments. In the example shown in FIG. 2C, a multi-region PET-CT scan 291, which may depict multiple region of the body (e.g., a whole body scan and/or the like), may undergo processing prior to segmentation. As shown in FIG. 2C, the preprocessing of the multi-region PET-CT scan 291 may include extracting, from the multi-region PET-CT scan 291, a region-specific PET-CT scan 293 that depicts a first region but not a second region of the body. In some cases, the preprocessing may further include removing the background from the region-specific PET-CT scan 293 extracted from the multi-region PET-CT scan 291 to increase the background homogeneity of the region-specific PET-CT scan 293. In some cases, the preprocessing may also include resampling the region-specific PET-CT scan 293, for example, adding and/or removing a quantity of voxels along one or more dimensions of the region-specific PET-CT scan 293 such that the region-specific PET-CT scan 293 resulting therefrom includes a threshold quantity of voxels along each dimension (e.g., 128×128×128). In some cases, the region-specific PET-CT scan 293 may be resampled to increase the signal-to-noise ratio (SNR) between the signal associated with a first quantity of voxels depicting a lesion and the noise associated with a second quantity of background voxels (or voxels not depicting a lesion). As shown in FIG. 2C, the region-specific PET-CT scan 293 that is generated as a result of the preprocessing of the multi-region PET-CT scan 291 may then undergo segmentation. In some cases, the segmentation may include applying, to the region specific PET-CT scan 293, the segmentation model 113 to generate the tumor mask 295. In some cases, the segmentation model 113 may generate the tumor mask 295 to localize one or more lesions present in the multi-region PET-CT scan 291 by at least assigning a first value (e.g., “1”) to each voxel depicting a lesion and a second value (e.g., “0”) to each voxel not depicting a lesion.

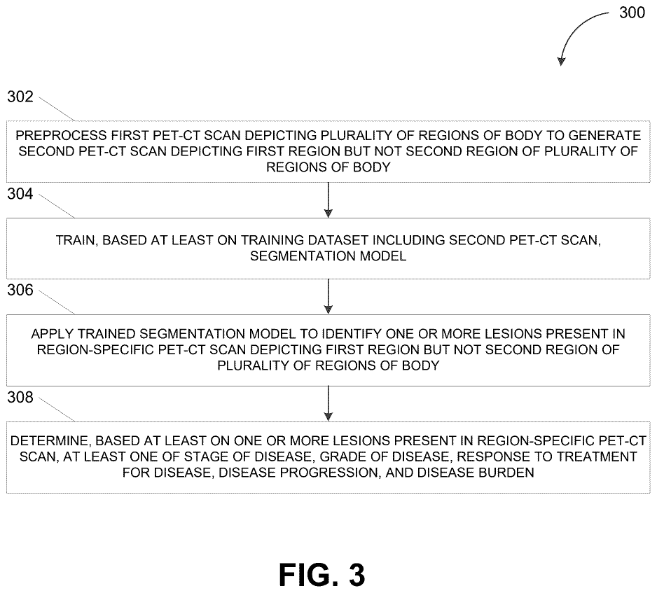

FIG. 3 depicts a flowchart illustrating an example of a process 300 for machine learning enabled lesion segmentation in positron emission tomography (PET) and computed tomography (CT) scans, in accordance with some example embodiments. Referring to FIGS. 1, 2A-B, and 3, the process 300 may be performed by the analysis controller 110 to train and apply the segmentation model 113 to perform lesion segmentation in one or more region-specific PET-CT scans.

At 302, the analysis controller 110 may preprocess a first PET-CT scan depicting a plurality of regions of a body to generate a second PET-CT scan depicting a first region but not a second region of the plurality of regions of the body. In some example embodiments, the preprocessing engine 111 of the analysis controller 110 may preprocess, for example, the first PET-CT scan 210 depicting multiple regions of the body by at least extracting, from the first PET-CT scan 210, a first portion of the first PET-CT scan 210 depicting a first region but not a second region of the body. In doing so, the preprocessing engine 111 may generate the second PET-CT scan 220 having one or more initial dimensions. As described in more detail below, the second PET-CT scan 220 may be further preprocessed by at least adjusting the second PET-CT scan 220 from the one or more initial dimensions to one or more target dimensions. The preprocessing of the first PET-CT scan 210 to generate the second PET-CT scan 220 to exhibit a higher signal-to-noise ratio (SNR) and background homogeneity than the first PET-CT scan 210. Accordingly, the segmentation model 113 may perform better (e.g., with better precision, recall, F1 score, and/or the like) when trained on the second PET-CT scan 220 than when trained on the first PET-CT scan 210.

At 304, the analysis controller 110 may train, based at least on a training dataset including the second PET-CT scan, a segmentation model. In some example embodiments, the analysis controller 110 may train, based at least on a training dataset including the second PET-CT scan 220, the segmentation model 113 to perform lesion segmentation. In the example shown in FIG. 2A, for instance, the training of the segmentation model 113 may include applying the segmentation model 113 to generate the tumor mask 225, which identifies a first plurality of voxels depicting one or more lesions in the second PET-CT scan 220. That is, in some cases, the segmentation model 113 may generate the tumor mask 225 by at least assigning, to each voxel in the second PET-CT scan 220, a first value (e.g., “1”) to identify the voxel as depicting a lesion and a second value (e.g., “0”) to identify the voxel is not depicting a lesion. To train the segmentation model 113, the analysis controller 110 may adjust the segmentation model 113 (e.g., one or more of the weights applied by the segmentation model 113) in order to minimize an error in the output of the segmentation model 113. In the example shown in FIG. 2A, the error in the output of the segmentation model 113 may include a difference between the tumor mask 225 and the ground truth tumor mask 227, which identifies a second plurality of voxels depicting one or more actual lesions present in the second PET-CT scan 220. It should be appreciated that the segmentation model 113 may undergo one or more training iterations, each of which includes the segmentation model 113 being adjusted to minimize the error in the output of the segmentation model 113 applied to one or more training samples of region-specific PET-CT scans such as the second PET-CT scan 220.

In some example embodiments, the parameters (e.g., weights, biases, and/or the like) of the segmentation model 113 may be initially set to values selected randomly from a normal distribution. In some cases, gradient descent, such as stochastic gradient descent, may be performed to adjust the parameters of the segmentation 113 to reduce (or minimize) a loss function quantifying the error in the output of the segmentation model 113. Equation (1) below is an example of a loss function that includes cross entropy loss and dice loss to address the imbalance between classes present in the training samples. In Equation (1), V denotes the individual voxels within an PET-CT scan, T denotes the set of voxels depicting a lesion (positive pixels) in the ground truth, P denotes the set of voxels predicted as depicting a lesion by the segmentation model 113, yᵥ denotes the value of the voxel v in the ground truth tumor mask, and ŷᵥ is the value of the voxel v in the tumor mask predicted by the segmentation model 113. In the context of lesion segmentation, class imbalance may refer to the significantly higher proportion of voxels not depicting a lesion (or negative voxels) relative to those that do depict a lesion (or positive voxels). A loss function that combines both losses, such as Equation (1), mitigates the effect of class imbalance and encourages the segmentation model 113 to produce accurate pixel-wise probabilities and well-defined lesion boundaries.

$$L = [ 1 - \frac{2 \vert P ⋂ T \vert + 1}{\vert P \vert + \vert T \vert + 1} ] - [ {\sum }_{v ∈ V} \frac{\vert V \vert}{{\sum }_{v ∈ V} {y}_{v}} ( {y}_{v} log ( {\hat{y}}_{v} ) + ( 1 - \frac{\vert V \vert}{{\sum }_{v ∈ V} {y}_{v}} ( 1 - {y}_{v} ) log ( 1 - {\hat{y}}_{v} ) ) ) ] \qquad ( 1 )$$

At 306, the analysis controller 110 may apply the trained segmentation model to identify one or more lesions present in a region-specific PET-CT scan depicting the first region but not the second region of the plurality of regions of the body. In some example embodiments, the analysis controller 110 may apply the trained segmentation model 113 to identify one or more lesions present in, for example, the region-specific PET-CT scan 260. As shown in FIG. 2B, in some cases, the region-specific PET-CT scan 260 may be a region-specific PET-CT scan as a result of the preprocessing engine 111 preprocessing the multi-region PET-CT scan 270 by at least resampling a portion of the multi-region PET-CT scan 270 extracted from the multi-region PET-CT scan 270 that depicts the first region but not the second region of the body. In some cases, the trained segmentation model 113 may perform lesion segmentation on the region-specific PET-CT scan 260 by at least generating the tumor mask 277, which identifies a plurality of voxels in the region-specific PET-CT scan 260 that depict a lesion. For example, in some cases, the trained segmentation model 113 may generate the tumor mask 277 by at least assigning, to each voxel in the region-specific PET-Ct scan 260, a first value (e.g., “1”) to identify the voxel as depicting a lesion and a second value (e.g., “0”) to identify the voxel as not depicting a lesion. In the example shown in FIG. 2B, in some cases, the analysis controller 110 may include an assessment engine 115 that determines, based at least on the tumor mask 265, the tumor volume 280 (e.g., metabolic tumor volume, total metabolic tumor volume (TMTV), and/or the like). In some cases, the assessment engine 115 may further determine, based at least on the tumor volume 280, at least one of a stage of a disease, a grade of the disease, a response to a treatment for the disease, a progression of the disease, and a disease burden.

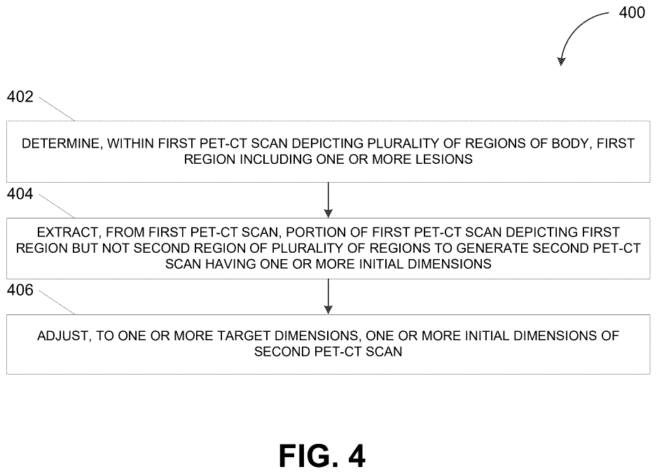

FIG. 4 depicts a flowchart illustrating an example of a process 400 for preprocessing a positron emission tomography and computed tomography (PET-CT) scan, in accordance with some example embodiments. Referring to FIGS. 1, 2A-B, and 3-4, in some cases the process 400 may be performed by the analysis controller 110, for example, the preprocessing engine 111. Furthermore, in some cases, the process 400 may implement operation 302 of the process 300 shown in FIG. 3. In some example embodiments, the process 400 may be performed to generate, based at least on a first PET-CT scan depicting a plurality of regions of a body, a second PET-CT scan depicting a first region but not a second region of the plurality of regions of the body. It should be appreciated that the second PET-CT scan may exhibit a higher signal-to-noise ratio (SNR) and background homogeneity than the first PET-CT scan at least because the exclusion of the second region of the body reduces the discrepancy in voxel intensity values that is present in the first PET-CT scan.

At 402, the preprocessing engine 111 may determine, within a first PET-CT scan depicting a plurality of regions of a body, a first region including one or more lesions. In some example embodiments, the analysis controller 110 may receive, from the one or more imaging devices 120, the first PET-CT scan 210, which may depict multiple regions of a body. For example, in some cases, the first PET-CT scan 210 may depict two or more of a head, a neck, upper extremities, thorax, abdomen, pelvis, and lower extremities. Moreover, in some cases, the first PET-CT scan 210 may depict multiple organs. In some cases, the preprocessing engine 111 may preprocess the first PET-CT scan by at least identifying, within the first PET-CT scan 210, at least one region of the body. For instance, in some cases, the preprocessing engine 111 may identify, within the first PET-CT scan 210, one or more regions of the body in which a lesion may be present. Alternatively, and/or additionally, the preprocessing engine 111 may identify, within the first PET-CT scan 210, one or more regions of the body containing at least one organ-of-interest such as, for example, small intestines, large intestines, lungs, thyroid, prostate, pancreas, cervix, and/or the like.

At 404, the preprocessing engine 111 may extract, from the first PET-CT scan, a portion of the first PET-CT scan depicting the first region but not a second region of the plurality of regions to generate a second PET-CT scan having one or more initial dimensions. In some example embodiments, the preprocessing engine 111 may extract, from the first PET-CT scan 210, a first portion of the first PET-CT scan 210 depicting the first region but not the second region of the plurality of regions of the body depicted in the first PET-CT scan 210. In doing so, the preprocessing engine 111 may generate the second PET-CT scan 220, which may depict the first region but not the second region of the body. That is, in some cases, the preprocessing engine 111 may generate the second PET-CT scan 220 by at least removing a second portion of the first PET-CT scan 210 depicting the second region of the body. In some cases, while the first PET-CT scan 210 depicts multiple organs of the body, the first portion of the first PET-CT scan 210 extracted therefrom to generate the second PET-CT scan 220 may depict some but not all of the organs depicted in the first PET-CT scan 210. For example, in some cases, whereas the first region of the body depicted in the first portion of the first PET-CT scan 210 extracted to form the second PET-CT scan 220 may depict a first organ, the second region of the body that is excluded from the second PET-CT scan 220 may depict a second organ but not the first organ.

In some example embodiments, the preprocessing engine 111 may extract the first portion of the first PET-CT scan 210 depicting the first region of the body by at least identifying a plurality of voxels to form the first portion of the first PET-CT scan 210 based at least on a range of intensity values exhibited by the plurality of voxels. For example, in some cases, the preprocessing engine 111 may extract the first portion of the first PET-CT scan 210 by at least identifying a plurality of voxels to form the first portion of the first PET-CT scan 210 based at least on a difference between a maximum intensity value and a minimum intensity value exhibited by the plurality of voxels. Accordingly, when extracting the first portion of the first PET-CT scan 210, the preprocessing engine 111 may avoid including voxels whose intensity value skews the range of intensity values present in the first portion of the first PET-CT scan 210, thereby maximizing the signal-to-noise ratio (SNR) and the background homogeneity of the second PET-CT scan 220 generated therefrom. For instance, in some cases, the preprocessing engine 111 may determine a first range of intensity values exhibited by the first portion of the first PET-CT scan 210 excluding the voxel and a second range of intensity values exhibited by the first portion of the first PET-CT scan 210 including the voxel. In cases where the difference between the first range of intensity values and the second range of intensity values satisfies one or more thresholds, the preprocessing engine 111 may extract that voxel when extracting the first portion of the first PET-CT scan 210. Alternatively, where the difference between the first range of intensity values and the second range of intensity values fails to satisfy the one or more thresholds, the preprocessing engine 111 may exclude the voxel when extracting the first portion of the first PET-CT scan 210.

At 406, the preprocessing engine 111 may adjust, to one or more target dimensions, the one or more initial dimensions of the second PET-CT scan. In some example embodiments, the second PET-CT scan 220 that is generated by the preprocessing engine 111 extracting the first portion of the first PET-CT scan 210 may have one or more initial dimensions. However, in order to further optimize the performance of the segmentation model 113, the preprocessing engine 111 may resample the second PET-CT scan 220 to increase the resolution of the first portion of the first PET-CT scan 210 extracted from the first PET-CT scan 210. For example, in some cases, the preprocessing engine 111 may resample the second PET-CT scan 220 by at least adjusting, to one or more target dimensions, the one or more initial dimensions of the second PET-CT scan 220.

In some example embodiments, the preprocessing engine 111 may adjust the one or more initial dimensions of the second PET-CT scan 220 by at least performing a first adjustment to a first dimension of the second PET-CT scan 220. For example, in some cases, the first adjustment may include adding, to a first quantity of voxels along the first dimension of the second PET-CT scan 220, at least a first voxel to increase the first quantity of voxels to a maximum quantity of voxels (e.g., 64, 128, 256, 512, and/or the like). Furthermore, the preprocessing engine 111 may determine the first value of the first voxel added to the first dimension of the second PET-CT scan 220. For instance, in some cases, the preprocessing engine 111 may determine, based at least on a second value of a second voxel within a threshold distance of the first voxel, the first value of the first voxel. In some cases, the first value of the first voxel may correspond to a first level of metabolic activity and a first tissue density at a first location of the first voxel while the second value of the second voxel may correspond to a second level of metabolic activity and a second tissue density at a second location of the second voxel.

In some example embodiments, the preprocessing engine 111 may adjust the one or more initial dimensions of the second PET-CT scan 220 by at least performing, based at least on the first adjustment made to the first dimension of the second PET-CT scan 220, a second adjustment to a second dimension of the second PET-CT scan 220 and a third adjustment to a third dimension of the second PET-CT scan 220. In some cases, the second adjustment to the second dimension of the second PET-CT scan 220 may include adding, to a second quantity of voxels along the second dimension of the second PET-CT scan 220, at least a second voxel to increase the second quantity of voxels to the maximum quantity of voxels (e.g., 64, 128, 256, 512, and/or the like). Meanwhile, the third adjustment to the third dimension of the second PET-CT scan 220 may include adding, to a third quantity of voxels along the third dimension of the second PET-CT scan 220, at least a third voxel to increase the third quantity of voxels to the maximum quantity of voxels (e.g., 64, 128, 256, 512, and/or the like). In some cases, the second voxel added to the second dimension of the second PET-CT scan 220 and the third voxel added to the third dimension of the second PET-CT scan 220 may each be assigned a first value (e.g., “0)” corresponding to the level of metabolic activity and a second value (e.g., “−1024”) corresponding to the tissue density or x-ray attenuation.

As noted, training the segmentation model 113 to operate on the second PET-CT scan 220 may improve the performance of the segmentation model 113 at least because the second PET-CT scan 220 may exhibit a higher signal-to-noise ratio (SNR) and background homogeneity than the first PET-CT scan 210 from which the analysis controller 110 (e.g., the preprocessing engine 111) extracted the second PET-CT scan 220. In some cases, this improvement in the performance of the segmentation model 113 may be attributable at least in part to the exclusion of at least the second portion of the first PET-CT scan 210 occupied by voxels exhibiting a different range of intensity values than the voxels in the first portion of the first PET-CT scan 210 extracted and resampled to form the second PET-CT scan 220.

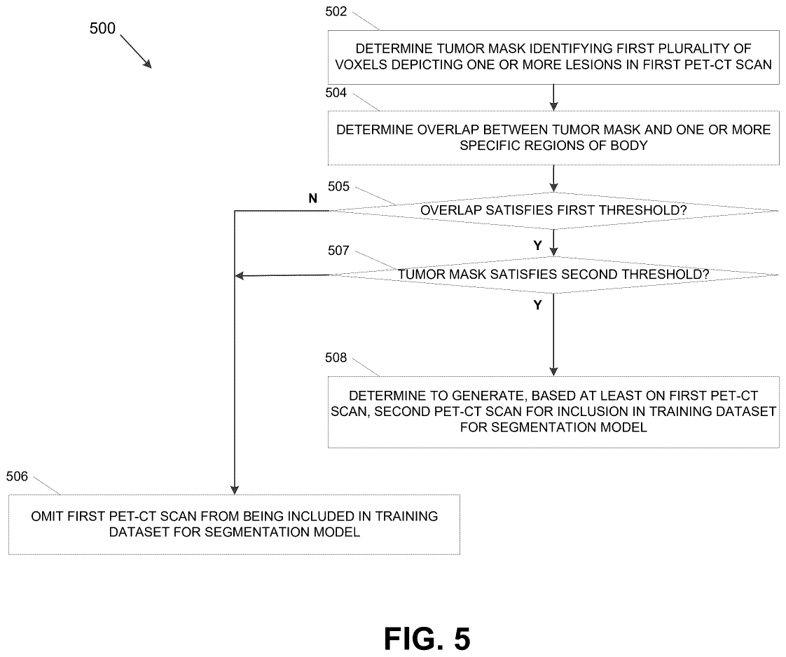

FIG. 5 depicts a flowchart illustrating an example of a process 500 for identifying one or more positron emission tomography and computed tomography (PET-CT) scans for inclusion in a training dataset, in accordance with some example embodiments. Referring to FIGS. 1, 2A-B, 3, and 5, in some cases the process 500 may be performed by the analysis controller 110 to identify one or more PET-CT scans to undergo preprocessing, for example, the preprocessing engine 111 in order to generate one or more corresponding training samples for inclusion in a training dataset for the segmentation model 113. In some example embodiments, the analysis engine 110 may perform the process 500 in order to avoid preprocessing PET-CT scans that do not depict sufficiently large lesions in a particular region of the body.

At 502, the analysis controller 110 may determine a tumor mask identifying a first plurality of voxels depicting one or more lesions in a first PET-CT scan. In some example embodiments, the analysis controller 110 may determine a tumor mask that identifies a first plurality of voxels depicting one or more lesions in the first PET-CT scan 210. In some cases, the first PET-CT scan 210 may depict multiple regions of the body. As such, the tumor mask may identify lesions present in multiple regions of the body.

At 504, the analysis controller 110 may determine an overlap between the tumor mask and one or more specific regions of the body. In some example embodiments, the analysis controller 110 may determine an overlap between the tumor mask and the first region of the body. In some cases, the first region of the body may contain one or more organs-of-interest (small intestines, large intestines, lungs, thyroid, prostate, pancreas, cervix, and/or the like). Accordingly, in some cases, the analysis controller 110 may determine an overlap between the tumor mask and an organ mask identifying a second plurality of voxels depicting one or more organs-of-interest present in the first region of the body. As described in more detail below, the analysis controller 110 may avoid preprocessing the first PET-CT scan 210, for example, to generate the second PET-CT scan 220 for inclusion in the training dataset for the segmentation model 113, if the first PET-CT scan 210 does not include one or more lesions in the first region of the body.

At 505-N, the analysis controller 110 may determine that the overlap between the tumor mask and one or more specific regions of the body fails to satisfy a first threshold. Accordingly, at 506, the analysis controller 110 may determine to omit the first PET-CT scan from being included in a training dataset for a segmentation model. For example, in some cases, the analysis controller 110 may avoid preprocessing the first PET-CT scan 220, for example, to generate the second PET-CT scan 220 for inclusion in the training dataset for the segmentation model 113, if the first PET-CT scan 210 does not include any lesions whose overlap with the first region of the body (or one or more organs-of-interest in the first region of the body) satisfies a first threshold (e.g., 20% and/or the like).

Alternatively, at 505-Y, the analysis controller 110 may determine that the overlap between the tumor mask and one or more specific regions of the body satisfies the first threshold. Accordingly, at 507, the analysis controller 110 may determine whether the tumor mask satisfies a second threshold including at least one of a tumor volume and a distance to another lesion. In some cases, the analysis controller 110 may determine that the first PET-CT scan 210 includes at least one lesion whose overlap with the first region of the body (or the one or more organs-of-interest in the first region of the body) satisfies a first threshold (e.g., 20% and/or the like). Accordingly, the analysis controller 110 may further verify whether the at least one lesion present in the first region of the body (or the one or more specific organs in the one or more regions of the body) is an actual lesion or an artifact (e.g., associated with the one or more imaging devices 120). For example, in some cases, upon determining that the overlap between the tumor mask and the first region of the body satisfies the first threshold (e.g., 20% and/or the like), the analysis controller 110 may further determine whether the tumor mask satisfies a second threshold that includes at least one of a tumor volume and a distance to another lesion. The imposition of the second threshold may ensure that the analysis controller 110 avoids preprocessing the first PET-CT scan 210 if the lesions present in the first region of the body are below a threshold volume (e.g., 8 milliliters) and are beyond a threshold distance (e.g., 10 voxels and/or the like) apart from another lesion. Small lesions that are distant from another lesion tend to be artifacts and not actual lesions. Accordingly, if the first PET-CT scan 210 does not contain any lesions within the first region of the body that are sufficiently large or close to another lesion to not be an artifact, the analysis controller 110 may avoid preprocessing the first PET-CT scan 210 to generate the second PET-CT scan 220 for inclusion in the training dataset for the segmentation model 113.

At 507-Y, the analysis controller 110 may determine the tumor mask satisfies the second threshold. Accordingly, at 508, the analysis controller 110 may determine to generate, based at least on the first PET-CT scan, a second PET-CT scan for inclusion in the training dataset for the segmentation model. In some example embodiments, where the analysis controller 110 determines that the tumor mask satisfies the second threshold, the analysis controller 110 may determine the further preprocess the first PET-CT scan 210 to generate, for example, the second PET-CT scan 220 for inclusion in the training dataset for the segmentation model 113. In instances where the tumor mask associated with the first PET-CT scan 210 satisfies the first threshold as well as the second threshold, the analysis controller 110 may determine that the first PET-CT scan 210 not only depicts lesions in the first region of the body (or the one or more specific organs in the one or more regions of the body), but those lesions are sufficiently large or close to another lesion to not be artifacts (e.g., associated with the one or more imaging devices 120). When that is the case, the first PET-CT scan 210 may undergo preprocessing, for example, by the preprocessing engine 110 where the first portion of the first PET-CT scan 210 depicting the first region of the body but not the second region of the body may be extracted and resampled to generate the second PET-CT scan 220.

Alternatively, at 507-N, the analysis controller 110 may determine that the tumor mask fails to satisfy the second threshold including at least one of the tumor volume and the distance to another lesion. Accordingly, the process 500 may resume at operation 504 in which the analysis controller 110 determines to omit the first PET-CT scan from being included in a training dataset for a segmentation model. In some cases, even though the first PET-CT scan 210 depicts one or more lesions in the first region of the body (or one or more organs-of-interest in the first region of the body), those lesions may be too small (e.g., below 8 milliliters in volume) and/or too distant away (e.g., more than 10 voxels) from another lesion to be actual lesions. Accordingly, where the tumor mask of the first PET-CT scan 210 satisfies the first threshold but not the second threshold, the analysis controller 110 may also avoid preprocessing the first PET-CT scan 210 to generate the second PET-CT scan 220 for inclusion in the training dataset for the segmentation model 113.

The performance of the segmentation model 113 was evaluated using Dice scores to assess the accuracy of the region-specific (e.g., organ-focused) approach relative to the multi-region (e.g., whole-body) approach. The performance of the segmentation model 113 was assessed on the lesion-level by calculating precision, recall, and F1 score. Total metabolic volume (TMV) was also computed for the tumor masks predicted by the segmentation model 113 implementing a region-specific (e.g., organ-focused) approach as well as a multi-region (e.g., whole-body) approach before those tumor masks were compared to the corresponding ground-truth tumor masks to show that the region-specific (e.g., organ-focused) approach yielded tumor mask with greater correlation with the ground-truth tumor masks in computing the burden of metabolically active disease in patients with lymphomas. A Spearman correlation coefficient was also computed for each approach in order to provide a statistical measure for evaluating the strength of the relationship between the predicted results and the ground truth in each case.

To calculate the precision, recall, and F1 score for the lesion-level analysis performed by the segmentation model 113, the lesions identified in the ground truth tumor mask are compared against those in the predicted tumor masks. A lesion in the predicted tumor mask is classified as a true positive (TP) if it had a threshold overlap (e.g., 20 percent) with a lesion in the ground truth tumor mask. Conversely, a lesion in the predicted tumor mask is classified as a false positive (FP) if it exhibits less than the threshold overlap (e.g., 20 percent) with a lesion in the ground truth tumor mask. False negatives (FN) are lesions in the ground truth tumor mask with less than a threshold overlap (e.g., 20 percent) with a lesion in the predicted tumor mask. Equation (2) below illustrates the computation of precision, recall, and F1 score based on the incidences of true positives (TP), false positives (FP), and false negatives (FN). It should be appreciated that a higher F1 score suggests a better balance between precision and recall.

$$precision = \frac{T P}{T P + F P} \qquad ( 2 )$$

$$recall = \frac{T P}{T P + F N}$$

$$F 1 = \frac{2 \times ( precision \times recall )}{( precision \times recall )}$$

The segmentation model 113 was applied to the Goya test set and the Gallium test set. The quantitative results for the Goya test set are shown in Table 1 while the quantitative results for the Gallium test set are shown in Table 2. Both the Dice score and the lesion level metric F1 demonstrate that the region-specific (e.g., organ-focused) approach outperforms the multi-region (e.g., whole-body) approach.

TABLE 1

| Goya | Dice | Precision | Recall | F1 |
|---|---|---|---|---|
| Region-specific | 0.78 ± 0.21 | 0.88 | 0.84 | 0.86 |
| (organ-focused) | | | | |
| Multi-region | 0.63 ± 0.30 | 0.81 | 0.78 | 0.79 |
| (whole-body)! | | | | |

TABLE 2

| Gallium | Dice | Precision | Recall | F1 |
|---|---|---|---|---|
| Region-specific | 0.70 ± 0.25 | 0.68 | 0.71 | 0.69 |
| (organ-focused) | | | | |
| Multi-region | 0.58 ± 0.31 | 0.74 | 0.59 | 0.65 |
| (whole-body)! | | | | |

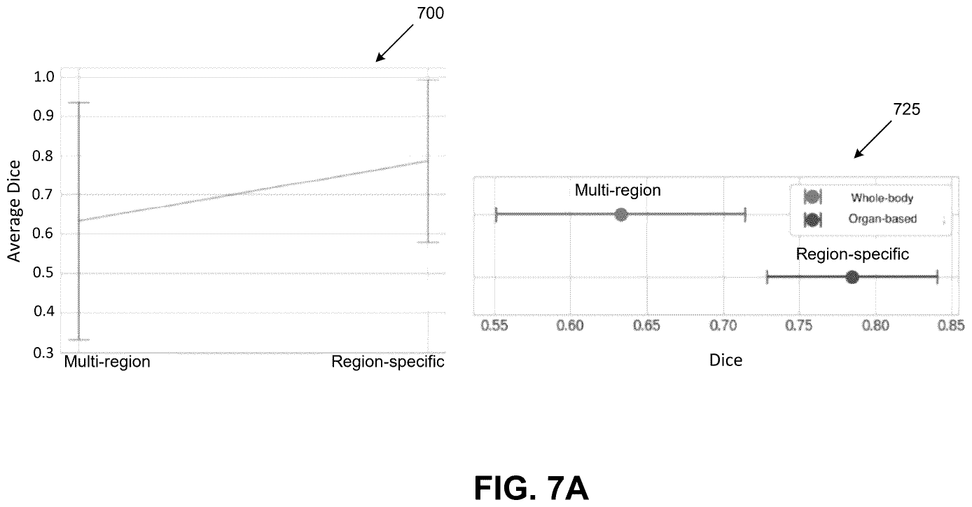

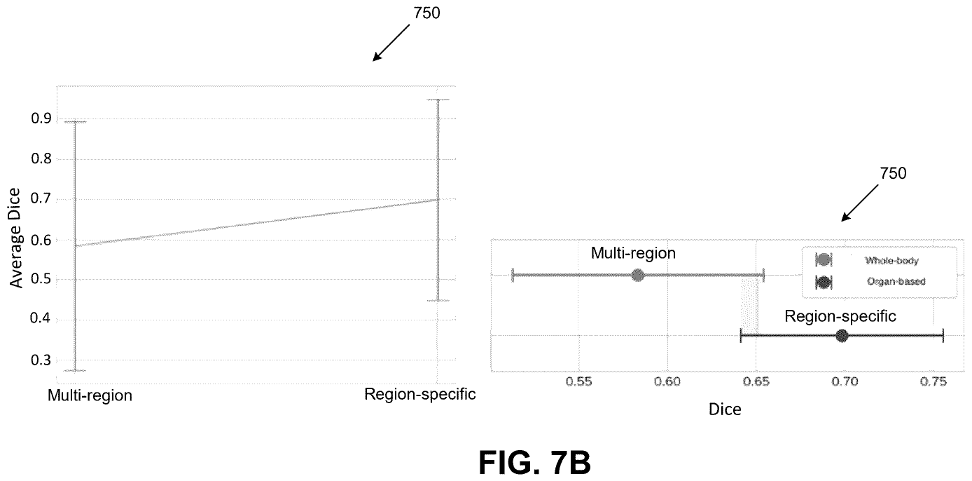

FIGS. 7A-B depict graphs illustrating the average Dice score with standard deviations and confidence intervals for both the region-specific (e.g., organ-focused) approach and the multi-region (e.g., whole-body) approach. As shown in FIGS. 7A-B, the region-specific (e.g., organ-focused) approach achieved better Dice scores at a statistically significant level for both test sets (e.g., p<10⁻⁵ in Goya and p<10⁻³ in Gallium). FIGS. 7A-B also shows that the region-specific (e.g., organ-focused) approach is capable of generating intestinal tumor segmentation results with less variability and greater consistency across different cases (e.g., smaller standard deviation) than the multi-region (e.g., whole-body) approach.

For example, graph 700 in FIG. 7A includes, on the far left, one (vertical) error bar illustrating the spread in the average Dice score of the multi-region (e.g., whole-body) method. On the far right of graph 700 is another (vertical) error bar illustrating the spread in the average Dice score of the region-specific (e.g., organ-focused) method. The horizontal line connecting the median Dice score for the multi-region (e.g., whole-body) method and the region-specific (e.g., organ-focused) method shows the region-specific (e.g., organ-focused) method. Graph 700 shows the region-specific (e.g., organ-focused) method as having achieved not only a higher average Dice score overall with less variability but also a higher median Dice score than the multi-region (e.g., whole-body) approach for the Goya test set. Graph 725 compares the 95% confidence intervals of the Dice scores for the multi-region (e.g., whole-body) approach and the region-specific (e.g., organ-focused) approach. As shown in FIG. 725, the region-specific (e.g., organ-focused) method achieved significantly higher Dice scores in the 95% confidence interval of the Goya test set.

In FIG. 7B, graph 750 include one (vertical) error bar on the far left illustrating the spread in the average Dice score of the multi-region (e.g., whole-body) method and another (vertical) error bar on the far right illustrating the spread in the average Dice score of the region-specific (e.g., organ-focused) method. The horizontal line connecting the median Dice score for the multi-region (e.g., whole-body) method and the region-specific (e.g., organ-focused) method shows the region-specific (e.g., organ-focused) method. Graph 750 shows the region-specific (e.g., organ-focused) method as having achieved not only a higher average Dice score overall with less variability but also a higher median Dice score than the multi-region (e.g., whole-body) approach for the Gallium test set. Graph 750 compares the 95% confidence intervals of the Dice scores for the multi-region (e.g., whole-body) approach and the region-specific (e.g., organ-focused) approach. As shown in FIG. 750, the region-specific (e.g., organ-focused) method also achieved significantly higher Dice scores in the 95% confidence interval of the Gallium test set.

The region-specific (e.g., organ-focused) approach also showed better compatibility in terms of the Dice score with the ground truth tumor mask than the multi-region (e.g., whole-body) approach in the Gallium test set (e.g., Table 2, 0.70 versus 0.58, p<10⁻³). Higher Dice score indicates better overall overlap and similarity between the predicted tumor mask and the ground truth tumor masks. A higher Dice score is desirable in the context of lesion segmentation because it indicates an ability to accurately capture true positive regions while minimizing the incidence of false negatives.

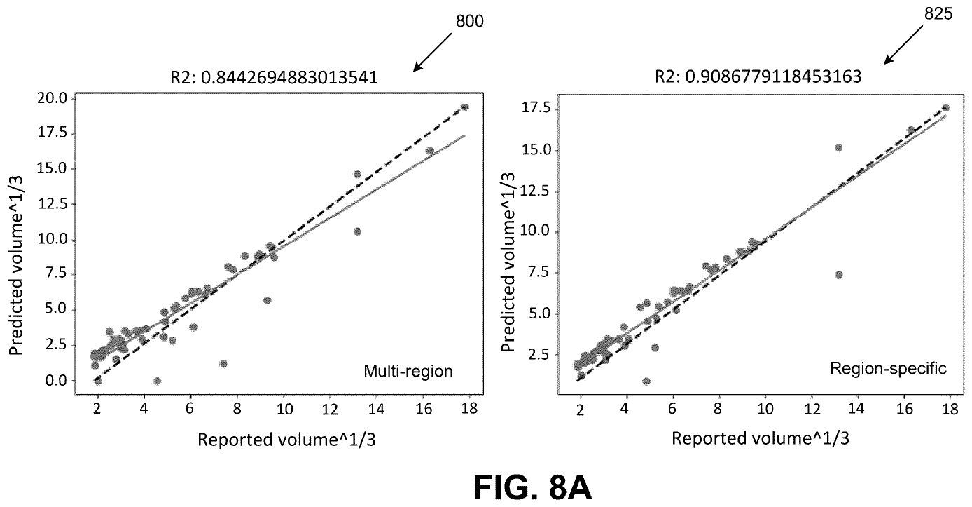

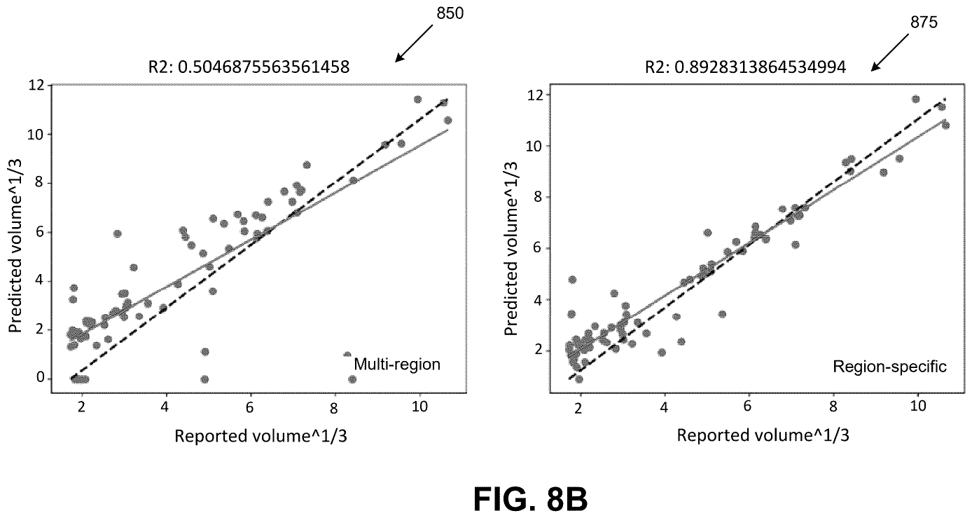

Intestinal metabolic tumor volume was calculated for each of the predicted tumor masks generated by both approaches and compared to the volumes in the ground truth tumor masks. FIGS. 8A-B depict a comparison of the predicted total metabolic tumor volume with the corresponding ground truth values for diffuse large B-cell lymphoma (DLBCL) and follicular lymphoma (FL) patients using the region-specific (e.g., organ-focused) approach and the multi-region (e.g., whole-body) approach. In FIG. 8A, which is for diffuse large B-cell lymphoma (DLBCL) patients, graph 800 illustrates the relationship between the reported (ground-truth) metabolic tumor volume and the predicted total metabolic tumor volume determined using the multi-region (e.g., whole-body) approach while graph 825 illustrates the relationship between the reported (ground-truth) metabolic tumor volume and the predicted total metabolic tumor volume determined using the region-specific (e.g., organ-focused) approach. In FIG. 8B, which is for follicular lymphoma (FL) patients, graph 850 illustrates the relationship between the reported (ground-truth) metabolic tumor volume and the predicted total metabolic tumor volume determined using the multi-region (e.g., whole-body) approach while graph 875 illustrates the relationship between the reported (ground-truth) metabolic tumor volume and the predicted total metabolic tumor volume determined using the region-specific (e.g., organ-focused) approach.

As shown in FIGS. 8A-B, the region-specific (e.g., organ-focused) approach yielded results that are well correlated with the ground truth values for estimating metabolic tumor burden, whereas the multi-region (e.g., whole-body) approach yielded a greater spread in data. Spearman's correlations for the region-specific (e.g., organ-focused) and multi-region (e.g., whole-body) approach are 0.86 and 0.93 respectively for the Goya test set, and 0.77 and 0.88 respectively for the Gallium test set. In addition, the multi-region (e.g., whole-body) approach and the region-specific (e.g., organ-focused) approach generated coefficients of determination (R²) of 0.84 and 0.91 respectively for the Goya test set, and 0.50 and 0.89 respectively for the Gallium test set. The aforementioned values for Spearman's correlation and coefficients of determination (R²) indicate a more consistent relationship between the region-specific (e.g., organ-focused) approach and the ground truth than the multi-region (e.g., whole-body) approach.

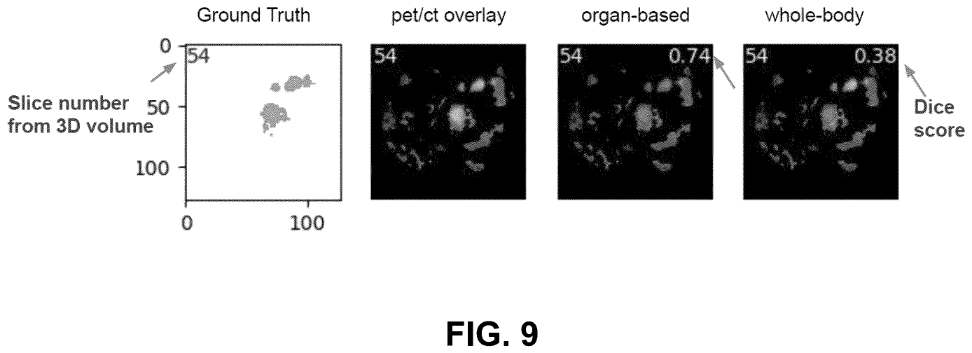

FIG. 9 depicts another comparison of a first performance of the segmentation model 113 trained to perform lesion segmentation on a region-specific PET-CT scan (such as the second PET-CT scan 220) and a second performance of the segmentation model 113 trained to perform lesion segmentation on a multi-region PET-CT scan (such as the first PET-CT scan 210). In the example shown in FIG. 9, the performance of the segmentation model 113 is gauged based on Dice score, which is a similarity metric quantifying a voxel-wise agreement between a predicted segmentation and the corresponding ground truth segmentation. When evaluated against the ground truth tumor mask, the segmentation model 113 trained to operate on the organ-focused PET-CT scan achieved a significantly higher Dice score than the segmentation model 113 trained to operate on the whole-body PET-CT scan.

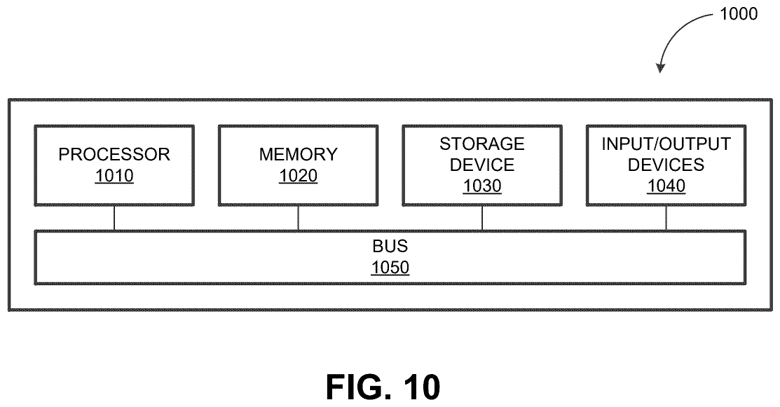

FIG. 10 depicts a block diagram illustrating an example of a computing system 1000 consistent with implementations of the current subject matter. Referring to FIGS. 1-1010, the computing system 1000 can be used to implement the analysis controller 110, the one or more imaging devices 120, the client device 130, and/or any components therein.

As shown in FIG. 1010, the computing system 1000 can include a processor 1010, a memory 1020, a storage device 1030, and an input/output device 1040. The processor 1010, the memory 1020, the storage device 1030, and the input/output device 1040 can be interconnected via a system bus 1050. The processor 1010 is capable of processing instructions for execution within the computing system 1000. Such executed instructions can implement one or more components of, for example, the analysis controller 110, the one or more imaging devices 120, and the client device 130. In some example embodiments, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a solid-state drive, a floppy disk device, a hard disk device, an optical disk device, or a tape device, or other suitable persistent storage means. The input/output device 1040 provides input/output operations for the computing system 1000. In some example embodiments, the input/output device 1040 includes a keyboard and/or pointing device. In various implementations, the input/output device 1040 includes a display unit for displaying graphical user interfaces.

According to some example embodiments, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some example embodiments, the computing system 1000 can be used to execute various interactive computer software applications that can be used for organization, analysis and/or storage of data in various formats. Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random query memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, recurrent provided to the user can be any form of sensory recurrent, such as for example visual recurrent, auditory recurrent, or tactile recurrent; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions, which when executed by the at least one data processor, result in operations comprising:
determining, within a first positron emission tomography and computed tomography (PET-CT) scan depicting a plurality of regions of a body, a first region including a first lesion;
extracting, from the first PET-CT scan, a first portion of the first PET-CT scan depicting the first region but not a second region of the plurality of regions to generate a second PET-CT scan having one or more initial dimensions;
adjusting, to one or more target dimensions, the one or more initial dimensions of the second PET-CT scan, the adjusting includes adding, to the second PET-CT scan, one or more voxels, and determining a value of each of the one or more voxels added to the second PET-CT scan;
training, based at least on a training dataset that includes the second PET-CT scan adjusted to the one or more target dimensions, a segmentation model; and
applying the trained segmentation model to identify one or more lesions present in a region-specific PET-CT scan depicting the first region but not the second region of the plurality of regions of the body.

2. The system of claim 1, further comprising:
determining a first tumor mask identifying a first plurality of voxels depicting one or more lesions present in the first PET-CT scan;
in response to determining that an overlap between the first tumor mask and the first region of the body satisfies a first threshold, generating the second PET-CT scan based at least on the first PET-CT scan by at least extracting the first portion of the first PET-CT scan;
in response to determining that at least one of a tumor volume and a distance to another lesion of the one or more lesions in the first tumor mask satisfy a second threshold, generating the second PET-CT scan based at least on the first PET-CT scan.

3. (canceled)

4. (canceled)

5. The system of claim 2, further comprising:
determining an organ mask identifying a second plurality of voxels depicting an organ of interest present in the first region of the body; and
in response to determining that an overlap between the first tumor mask and the organ mask satisfies the first threshold, generating the second PET-CT scan based at least on the first PET-CT scan.

6. The system of claim 2, further comprising:
determining a second tumor mask identifying a second plurality of voxels depicting one or more lesions present in a multi-region PET-CT scan; and
in response to determining that (i) an overlap between the second tumor mask and the first region of the body fails to satisfy the first threshold or (ii) the second tumor mask fails to satisfy a second threshold including at least one of a tumor volume and a distance to another lesion, generating the second PET-CT scan based on the first PET-CT scan but not the multi-region PET-CT scan.

7. The system of claim 1, further comprising:
generating the training dataset to include a first ground truth annotation identifying a first plurality of voxels depicting the first lesion in the second PET-CT scan;
determining that a second lesion present in the second PET-CT scan fails to satisfy one or more thresholds including at least one of a tumor volume and a distance to another lesion; and
in response to determining that the second lesion fails to satisfy the one or more thresholds, generating the training dataset to exclude a second ground truth annotation identifying a second plurality of voxels depicting the second lesion in the second PET-CT scan.

8. (canceled)

9. The system of claim 1, wherein the adjusting of the one or more initial dimensions of the second PET-CT scan includes
performing a first adjustment to a first dimension of the second PET-CT scan, and
performing, based at least on the first adjustment, a second adjustment to a second dimension of the second PET-CT scan and a third adjustment to a third dimension of the second PET-CT scan.

10. The system of claim 9, wherein the first adjustment to the first dimension of the second PET-CT scan includes
adding, to a first quantity of voxels along the first dimension of the second PET-CT scan, at least a first voxel to increase the first quantity of voxels to a maximum quantity of voxels, and
determining, based at least on a second value of a second voxel within a threshold distance of the first voxel, a first value of the first voxel.

11. (canceled)

12. The system of claim 10, wherein the first value of the first voxel corresponds to a first level of metabolic activity and a first tissue density at a first location of the first voxel, and wherein the second value of the second voxel corresponds to a second level of metabolic activity and a second tissue density at a second location of the second voxel.

13. The system of claim 12, wherein the second adjustment to the second dimension of the second PET-CT scan includes adding, to a second quantity of voxels along the second dimension of the second PET-CT scan, at least a second voxel to increase the second quantity of voxels to the maximum quantity of voxels, and wherein the third adjustment to the third dimension of the second PET-CT scan includes adding, to a third quantity of voxels along the third dimension of the second PET-CT scan, at least a third voxel to increase the third quantity of voxels to the maximum quantity of voxels.

14. The system of claim 13, wherein each of the second voxel and the third voxel are assigned a first value for a level of metabolic activity and a second value for tissue density or x-ray attenuation.

15. (canceled)

16. (canceled)

17. The system of claim 1, wherein the first PET-CT scan is a full-body scan of the body, and wherein the second PET-CT scan is generated to depict some but not all of the plurality of regions depicted in the full-body scan of the body.

18. The system of claim 1, wherein the plurality of regions of the body depicted in the first PET-CT scan includes a plurality of organs in the body, and wherein the second PET-CT scan is generated to depict some but not all of the plurality of organs in the body.

19. The system of claim 1, wherein the first region of the plurality of regions comprising the second PET-CT scan depicts at least a first organ, and wherein the second region of the plurality of regions removed from the first PET-CT scan depicts at least a second organ.

20. The system of claim 1, wherein the extracting of the first portion of the first PET-CT scan depicting the first region of the body includes identifying a plurality of voxels comprising the first portion of the first PET-CT scan based at least on a range of intensity values exhibited by the plurality of voxels.

21. The system of claim 1, wherein the extracting of the first portion of the first PET-CT scan depicting the first region of the body includes identifying a plurality of voxels comprising the first portion of the first PET-CT scan based at least on a difference between a maximum intensity value and a minimum intensity value exhibited by the plurality of voxels.

22. The system of claim 1, wherein the extracting of the first portion of the first PET-CT scan depicting the first region of the body includes
determining a first range of intensity values exhibited by the first portion of the first PET-CT scan excluding the voxel;
determining a second range of intensity values exhibited by the first portion of the first PET-CT scan including the voxel;
identifying, based at least on a difference between the first range of intensity values and the second range of intensity values satisfying one or more thresholds, the voxel for inclusion in the first portion of the first PET-CT scan; and
determining, based at least on the difference between the first range of values and the second range of values failing to satisfy the one or more thresholds, excluding the voxel from the first portion of the first PET-CT scan.

23. The system of claim 1, wherein the first region of the plurality of regions includes one of small intestines, large intestines, lungs, thyroid, prostate, pancreas, and cervix.

24. The system of claim 1, wherein the segmentation model includes an encoder and a decoder with one or more transformation blocks coupling an output of the encoder to an input of the decoder.

25. (canceled)

26. The system of claim 1, further comprising:
applying the trained segmentation model to identify, within the region-specific PET-CT scan, a plurality of voxels depicting the one or more lesions present in the first region of the body;
determining, based at least on the plurality of voxels, a metabolic tumor volume of the one or more lesions present in the first region of the body; and
determining, based at least on the metabolic tumor volume, at least one of a response to a stage of a disease, a grade of the disease, a treatment for the disease, a progression of the disease, and a disease burden.

27. (canceled)

28. (canceled)

29. The system of claim 1, wherein the first PET-CT scan and the second PET-CT scan are three-dimensional volumes comprising a series of two-dimensional slices.

30. (canceled)

31. A computer-implemented method, comprising:
determining, within a first positron emission tomography and computed tomography (PET-CT) scan depicting a plurality of regions of a body, a first region including a first lesion;
extracting, from the first PET-CT scan, a first portion of the first PET-CT scan depicting the first region but not a second region of the plurality of regions to generate a second PET-CT scan having one or more initial dimensions;
adjusting, to one or more target dimensions, the one or more initial dimensions of the second PET-CT scan, the adjusting includes adding, to the second PET-CT scan, one or more voxels, and determining a value of each of the one or more voxels added to the second PET-CT scan;
training, based at least on a training dataset that includes the second PET-CT scan adjusted to the one or more target dimensions, a segmentation model; and
applying the trained segmentation model to identify one or more lesions present in a region-specific PET-CT scan depicting the first region but not the second region of the plurality of regions of the body.

32. (canceled)
